(19) United States
(12) Patent Application Publication
(10) Pub. No.: US 2014/0324971 A1
(43) Pub. Date: Oct. 30, 2014

(54) DATA SHARING APPARATUS AND METHOD USING SOCIAL RELATION

(71) Applicant: ELECTRONICS AND TELECOMMUNICATIONS RESEARCH INSTITUTE, Daejeon (KR)

(72) Inventors: Jin-Young MOON, Daejeon (KR); Kyu-Chang KANG, Daejeon (KR); Joon-Young JUNG, Daejeon (KR); Dong-Oh KANG, Daejeon (KR); Chang-Seok BAE, Daejeon (KR)

(73) Assignee: ELECTRONICS AND TELECOMMUNICATIONS RESEARCH INSTITUTE, Daejeon (KR)

(21) Appl. No.: 14/259,504

(22) Filed: Apr. 23, 2014

(30) Foreign Application Priority Data
Apr. 24, 2013 (KR) 2013-0045400

(51) Int. Cl. H04L 29/06

(52) U.S. Cl. CPC H04L 65/403
USPC 709/204

(57) ABSTRACT

Provided is a data sharing apparatus and method for sharing data between a terminal possessed by a user and another terminal using social relations. The data sharing apparatus includes a social relation information acquisition unit that accesses a social network service (SNS) server for providing an SNS to acquire social relation information of a user, a social relation information storage unit that stores the acquired social relation information, and a data sharing control unit that controls data sharing between a user terminal possessed by the user and a target terminal based on the stored social relation information.

### CROSS-REFERENCE TO RELATED APPLICATION

This application claims priority to and the benefit of Korean Patent Application No. 10-2013-0045400, filed on Apr. 24, 2013, the disclosure of which is incorporated herein by reference in its entirety.

### BACKGROUND

1. Field of the Invention

The present invention relates to an apparatus and method for sharing data between different two terminals, and more particularly, to an apparatus and method for sharing data between a terminal possessed by a user and another terminal.

2. Discussion of Related Art

When a user desires to share pictures, moving pictures, documents, and the like with other persons, the user uses cloud services or data communication between terminals in a P2P method. When using the data communication, social relations of terminal users may be used for interconnection between terminal devices.

Conventional social network service (SNS) providers such as Facebook, Twitter, Goggle Plus, and the like provide a public application programming interface (API). When using the public API, terminal devices can be connected to each other using social relations. Thus, the conventional SNS providers provide contents generated by service users to an authenticated terminal using the public API.

As an apparatus for sharing data between terminal devices, Korean Publication Patent No. 2012-0062014 has been proposed. However, this user interface shares data between adjacent terminals in accordance with physical positions, and therefore there is a problem that contents of the user are leaked to complete strangers. This may lead to invasion of privacy and cause social problems.

### SUMMARY OF THE INVENTION

The present invention is directed to an apparatus and method for sharing data between a terminal possessed by a user and another terminal using social relations of the user.

According to an aspect of the present invention, there is provided a data sharing apparatus using social relations, including: a social relation information acquisition unit that accesses a social network service (SNS) server for providing an SNS to acquire social relation information of a user; a social relation information storage unit that stores the acquired social relation information; and a data sharing control unit that controls data sharing between a user terminal possessed by the user and a target terminal based on the stored social relation information.

The social relation information acquisition unit may acquire information about acquaintances of the user as first social relation information using a public application programming interface (API) obtained from the SNS server, or acquire information deduced based on an interaction frequency from activities performed by the user or the acquaintances by accessing the SNS server through the terminal, as second social relation information.

The social relation information acquisition unit may include a grouping unit that groups the acquaintances of the user in accordance with a determined reference when the acquaintances of the user are not grouped, and a list collection unit that acquires a group list generated in advance using the public API and an acquaintance list included in each group as the first social relation information, or acquires a group list generated through grouping in accordance with the predetermined reference using the public API and the acquaintance list included in each group as the first social relation information.

The social relation information acquisition unit may include an activity collection unit that collects activities generated by the user or the acquaintances in accordance with at least one method of posting, comments, tagging, and sharing setting, an activity extraction unit that extracts activities generated by a selected specific person among the acquaintances with respect to the user from the collected activities and activities generated by the user with respect to the specific person, an interaction frequency calculation unit that calculates an interaction frequency between the user and the specific person by adding up the extracted activities, a frequency calculation control unit that repeatedly drives the activity extraction unit and the interaction frequency calculation unit until the interaction frequencies with respect to all of the acquaintances are calculated, and a group information acquisition unit that groups the acquaintances in accordance with at least one reference value based on the interaction frequency calculated for each of the acquaintances, and acquires information acquired through grouping as the second social relation information.

The data sharing apparatus may further include a terminal verification unit that verifies whether the target terminal is a terminal possessed by the acquaintance of the user based on the stored social relation information; and a certification information generation unit that generates certification information for certifying that the target terminal is the terminal possessed by the acquaintance of the user when the target terminal is the terminal possessed by the acquaintance of the user, in which the data sharing control unit may control the data sharing to be performed between the user terminal and the target terminal by transmitting the certification information to the user terminal.

The data sharing apparatus may further include a model display unit that displays models representing each acquaintance on a screen of the user terminal, and arranges the models in order from front to back in accordance with the interaction frequency or arranges the models in order from center to outside on both sides to display the arranged models on the screen, in which the data sharing control unit may control the data sharing by using the terminal possessed by the model selected from the models displayed on the screen as the target terminal.

The model display unit may use any one of a name, a picture, and an icon of each acquaintance as the model representing each acquaintance.

According to an aspect of the present invention, there is provided a data sharing method including: acquiring social relation information of a user by accessing an SNS server for providing an SNS; storing the acquired social relation information; and controlling data sharing between a user terminal possessed by the user and a target terminal based on the stored social relation information.

The acquiring of the social relation information may include acquiring information about acquaintances of the user as first social relation information using a public API obtained from the SNS server or acquiring information deduced based on an interaction frequency from activities performed by the user or the acquaintances by accessing the SNS server through the terminal, as second social relation information.

The acquiring of the social relation information may include grouping the acquaintances of the user in accordance with a determined reference when the acquaintances of the user are not grouped, and acquiring a group list generated in advance using the public API and an acquaintance list included in each group as the first social relation information, or acquiring a group list generated through grouping in accordance with the predetermined reference using the public API and the acquaintance list included in each group as the first social relation information.

The acquiring of the social relation information may include collecting activities generated by the user or the acquaintances in accordance with at least one method of posting, comments, tagging, and sharing setting, extracting activities generated by a selected specific person among the acquaintances with respect to the user from the collected activities and activities generated by the user with respect to the specific person, calculating an interaction frequency between the user and the specific person by adding up the extracted activities, repeatedly performing the extracting of the activities and the calculating of the interaction frequency until the interaction frequencies with respect to all of the acquaintances are calculated, and grouping the acquaintances in accordance with at least one reference value based on the interaction frequency calculated for each of the acquaintances, and acquiring information acquired through grouping as the second social relation information.

The data sharing method may further include verifying whether the target terminal is a terminal possessed by the acquaintance of the user based on the stored social relation information; and generating certification information for certifying that the target terminal is the terminal possessed by the acquaintance of the user when the target terminal is the terminal possessed by the acquaintance of the user, in which the controlling of the data sharing may include controlling the data sharing to be performed between the user terminal and the target terminal by transmitting the certification information to the user terminal.

The data sharing method may further include displaying models representing each acquaintance on a screen of the user terminal, and arranging the models in order from front to back in accordance with the interaction frequency or arranging the models in order from center to outside on both sides to display the arranged models on the screen, in which the controlling of the data sharing may include controlling the data sharing by using the terminal possessed by the model selected from the models displayed on the screen as the target terminal.

The displaying of the models may include using any one of a name, a picture, and an icon of each acquaintance as the model representing each acquaintance.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram schematically showing a data sharing apparatus according to a preferred embodiment of the present invention;

FIG. 2 is a schematic diagram showing an inner configuration of a social relation information acquisition unit shown in FIG. 1 according to a first embodiment of the present invention;

FIG. 3 is a schematic diagram showing an inner configuration of a social relation information acquisition unit shown in FIG. 1 according to a second embodiment of the present invention;

FIG. 4 is a block diagram schematically showing an inner configuration added to the data sharing apparatus shown in FIG. 1;

FIG. 5 is a configuration diagram showing a data sharing system between mobile terminals using social relations according to an embodiment of the present invention;

FIGS. 6A, 6B, 6C and 7A and 7B are diagrams showing an example of a user interface according to the first embodiment of FIG. 2;

FIGS. 8A and 8B and 9 are diagrams showing an example of a user interface according to the second embodiment of FIG. 3; and

FIG. 10 is a flowchart schematically showing a data sharing method according to a preferred embodiment of the present invention.

### DESCRIPTION OF EXAMPLE EMBODIMENTS

Preferred embodiments of the present invention with reference to the accompanying drawings will be described in detail. First, the components of each drawing, a reference numeral is added as comprising about the same components even though shown in different drawings the same reference symbols as much as possible should be noted that the results so. Also, in describing the present invention, relating to a detailed description of known functions and configurations of the present invention may obscure the subject matter of if it is determined that a detailed description thereof will be omitted. Hereinafter, preferred embodiments of the invention will be described, the technical spirit of the present invention is not restricted or limited by those skilled in the art and various modifications and changes can be made of course.

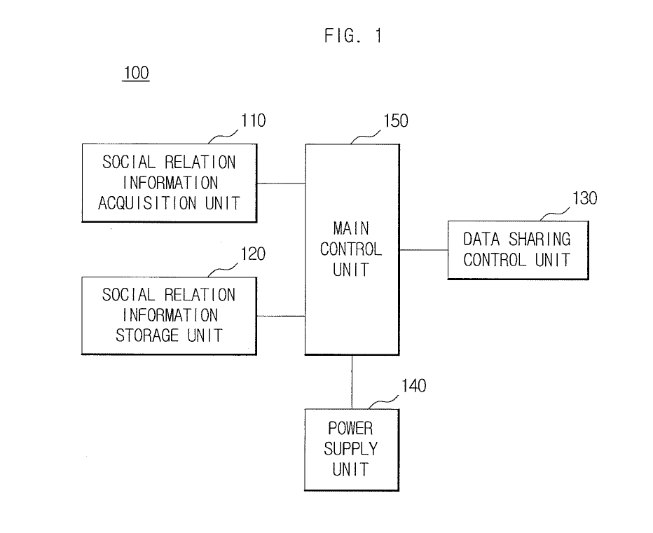

FIG. 1 is a block diagram schematically showing a data sharing apparatus according to a preferred embodiment of the present invention.

Referring to FIG. 1, the data sharing apparatus 100 includes a social relation information acquisition unit 110, a social relation information storage unit 120, a data sharing control unit 130, a power supply unit 140, and a main control unit 150. The power supply unit 140 supplies power to each component constituting the data sharing apparatus 100. The main control unit 150 controls overall operations of each component constituting the data sharing apparatus 100.

The social relation information acquisition unit 110 acquires social relation information of a user by accessing a social network service (SNS) server for providing an SNS.

The social relation information acquisition unit 110 may acquire information about acquaintances of the user as first social relation information using a public application programming interface (API) obtained from the SNS server. In the present embodiment, such a social relation information acquisition unit 110 is defined as the social relation information acquisition unit 110 according to a first embodiment.

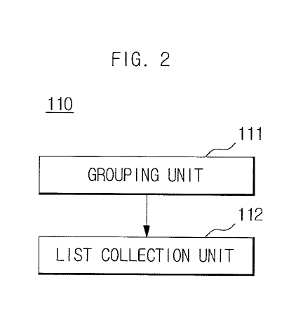

FIG. 2 is a schematic diagram showing an inner configuration of a social relation information acquisition unit 110 shown in FIG. 1 according to a first embodiment of the present invention. Referring to FIG. 2, the social relation information acquisition unit 110 includes a grouping unit 111 and a list collection unit 112.

The grouping unit 111 groups acquaintances of a user in a predetermined reference when the acquaintances of the user are not grouped.

The list collection unit 112 acquires a group list generated in advance and an acquaintance list included in each group as first social relation information using a public API when the acquaintances of the user are grouped. On the other hand, the list collection unit 112 acquires a group list generated through grouping in a predetermined reference and an acquaintance list included in each group as the first social relation information using the public API when the acquaintances of the user are not grouped.

The social relation information acquisition unit 110 may acquire information deduced based on an interaction frequency from activities performed by the user or the acquaintances of the user by accessing the SNS server through the terminal as second social relation information.

In the present embodiment, such a social relation information acquisition unit 110 is defined as the social relation information acquisition unit 110 according to a second embodiment.

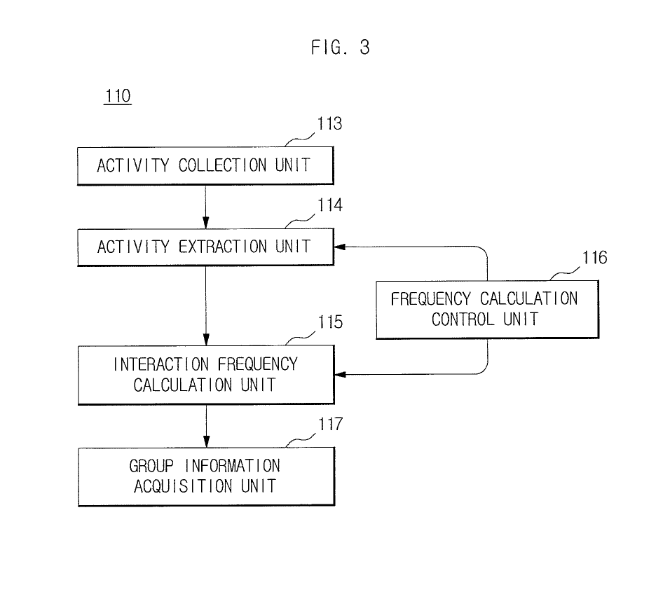

FIG. 3 is a schematic diagram showing an inner configuration of a social relation information acquisition unit 110 shown in FIG. 1 according to a second embodiment of the present invention. Referring to FIG. 3, the social relation information acquisition unit 110 includes an activity collection unit 113, an activity extraction unit 114, an interaction frequency calculation unit 115, a frequency calculation control unit 116, and a group information acquisition unit 117.

The activity collection unit 113 collects activities generated by the user or the acquaintances in accordance with at least one method of posting, comments, tagging, and sharing setting.

The activity extraction unit 114 extracts activities generated by a selected specific person among the acquaintances with respect to the user from the activities collected by the activity collection unit 113 and activities generated by the user with respect to the specific person.

The interaction frequency calculation unit 115 calculates an interaction frequency between the user and the specific person by adding up the activities extracted by the activity extraction unit 114.

The frequency calculation control unit 116 repeatedly drives the activity extraction unit 114 and the interaction frequency calculation unit 115 until the interaction frequencies with respect to all of the acquaintances are calculated.

The group information acquisition unit 117 groups the acquaintances in accordance with at least one reference value based on the interaction frequencies calculated for each acquaintance, and acquires the information acquired through grouping as the second social relation information.

The social relation information storage unit 120 stores the social relation information acquired by the social relation information acquisition unit 110.

The data sharing control unit 130 controls data sharing between a user terminal possessed by the user and a target terminal based on the social relation information stored by the social relation information storage unit 120.

The data sharing apparatus 100 may further include a terminal verification unit 160, a certification information generation unit 170, and a model display unit 180 other than the components shown in FIG. 1.

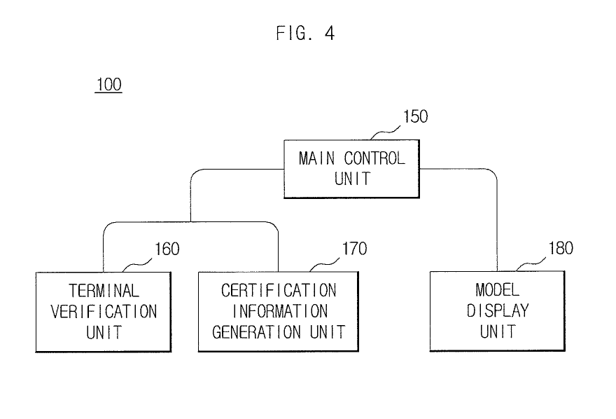

FIG. 4 is a block diagram schematically showing an inner configuration added to the data sharing apparatus 100 shown in FIG. 1. Referring to FIG. 4, the data sharing apparatus 100 may further include the terminal verification unit 160 organically linked with the data sharing control unit 130 and the certification information generation unit 170.

The terminal verification unit 160 verifies whether a target terminal is a terminal possessed by an acquaintance of a user based on the social relation information stored by the social relation information storage unit 120.

The certification information generation unit 170 generates certification information for certifying that the target terminal is the terminal possessed by the acquaintance of the user when the target terminal is the terminal possessed by the acquaintance of the user. In this instance, the data sharing control unit 130 controls data sharing between the user terminal and the target terminal to be performed by transmitting the certification information to the user terminal.

In addition, the data sharing apparatus 100 may further include a model display unit 180 organically linked with the data sharing control unit 130.

The model display unit 180 displays models representing each acquaintance on a screen of the user terminal. In particular, the model display unit 180 arranges the models in order from front to back in accordance with the interaction frequency, or arranges the models in order from center to outside on both sides to thereby display the arranged models on the screen. The model display unit 180 uses any one of a name, a picture, and an icon of each acquaintance as the model representing each acquaintance. The data sharing control unit 130 controls the data sharing by utilizing a terminal possessed by the model selected from the models displayed on the screen as the target terminal.

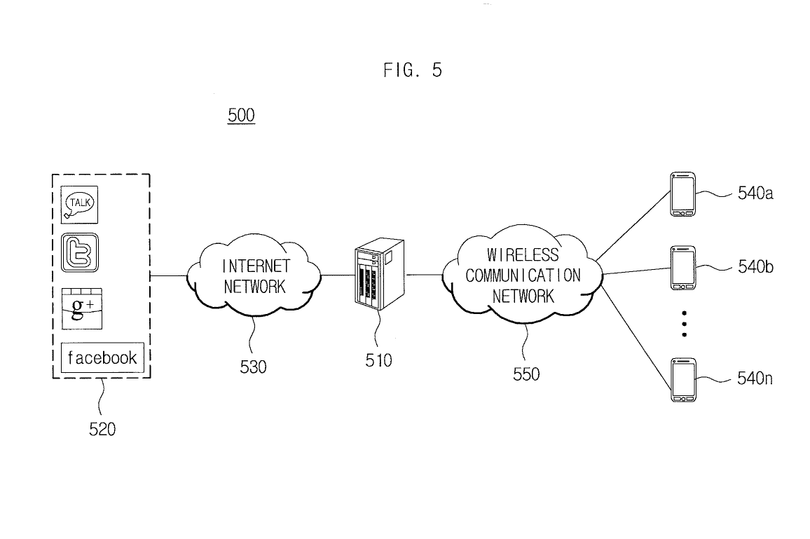

Hereinafter, a system for performing data sharing between mobile terminals using social relations according to an embodiment will be described. FIG. 5 is a configuration diagram showing a data sharing system 500 between mobile terminals using social relations according to an embodiment of the present invention.

Referring to FIG. 5, the data sharing system 500 includes a social relation management server 510, a social networking service 520, an Internet network 530, a wireless communication network 550, and user devices 540a, 540b, . . . , and 540n. The data sharing apparatus 100 described with reference to FIGS. 1 to 4 is obtained by modeling the social relation management server 510.

In order to minimize intervention of a user when performing data sharing between the mobile terminals 540a of users, the data sharing system 500 may select one or a group of terminals 540b, . . . , and 540n possessed by persons having social relations set in the social networking service 520 or persons having social relations with the user in accordance with an activity history of the user in the social networking service 520, and enable data to be shared between the terminals using the wireless communication network 550.

When the user shares data such as pictures, documents, or the like of his or her own mobile terminal 540a with other persons, the data may be shared with the terminals 540b, . . . , and 540n of persons having social relations through P2P communication using social relations which can be derived from the social networking service 520. The social relation management server 510 acquires social relations explicitly defined in the social networking service 520 such as with friends, family, alumni, and the like through a public API provided in the social networking service 520 such as Facebook, Twitter, Google Plus, KakaoTalk, or the like, or social relations deduced based on interaction between users from a history of activities performed by the user or the acquaintances of the user within the social networking service 520. The acquired social relations are stored in the social relation management server 510.

When a user shares data with persons having specific social relations with the user, the social relation management server 510 may acquire information which makes it possible to confirm whether any mobile terminal attempting to access the social relation management server 510 for communication is a mobile terminal possessed by a person included in corresponding social relations in which sharing is permitted, or a result obtained by verifying whether any mobile terminal attempting to access the social relation management server 510 for communication is the mobile terminal of the person included in corresponding social relations in which sharing is permitted. When it is not easy to access the social relation management server 510 each time the user shares the data, social relation information cached in the terminal may be used. When any mobile terminal attempting to access the social relation management server 510 for communication is determined as the mobile terminal of the person included in corresponding social relations in which sharing is permitted based on a result of verification performed in the mobile terminal using the social relation information or a verification result received from the social relation management server 510, data sharing is started by opening a communication channel.

When the user sets the terminal through which data is to be shared, social relations of the user are used. As the social relations, social relations based on groups such as friends, family, and the like defined in the social networking service 520 employed by the user, or affinity-based social relations deduced from a history of activities such as posting comments, attaching comments, showing feelings on comments, transmitting and receiving messages, and the like in the social networking service 520 may be used. As described above, the social relation management server 510 acquires the social relations using the following two primary methods which will be described in detail.

In a first method, social relation groups provided in the social networking service 520 are used. For example, Facebook or Google Plus can group acquaintances of a user having social relations with the user into close friends, OO schools, or the like. Here, social relations may be stored and managed based on a group list and a list of acquaintances belonging to each group list received from a public API provided by the social networking service 520. In the social networking service 520 in which group relations are not explicitly provided, groups are created through a provided API. For example, in Twitter, groups having two-way relationships, groups of persons who follow a user, and groups of persons whom the user follows may be created by combining followers and one-way relationships of following. In KakaoTalk, all acquaintances having social relations may create a single friend group.

The social relations generated in the first method can be provided to the user as a user interface so that a specific social relation group can be selected when receiving a request for data sharing from the user.

A user interface that provides a data sharing function based on the social relations generated in the first method is the same as in FIG. 1.

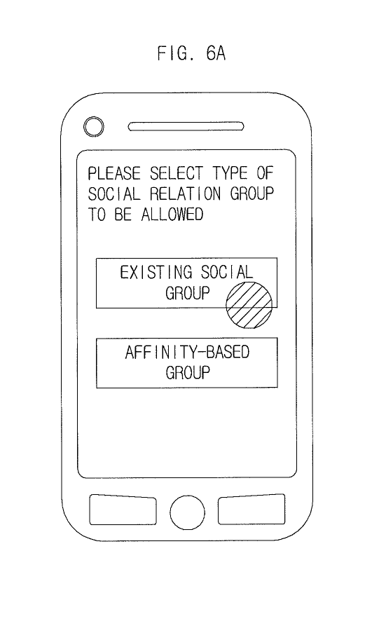

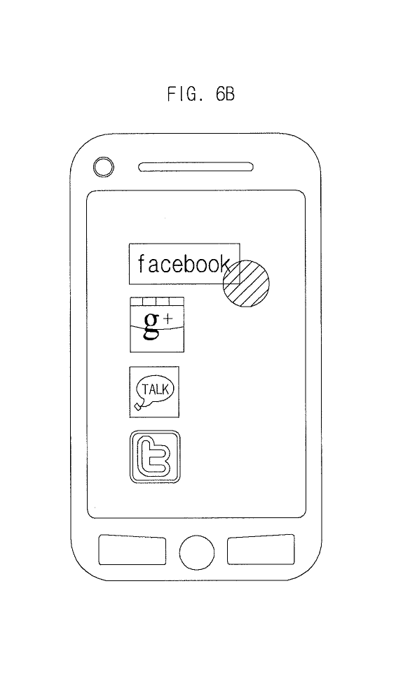

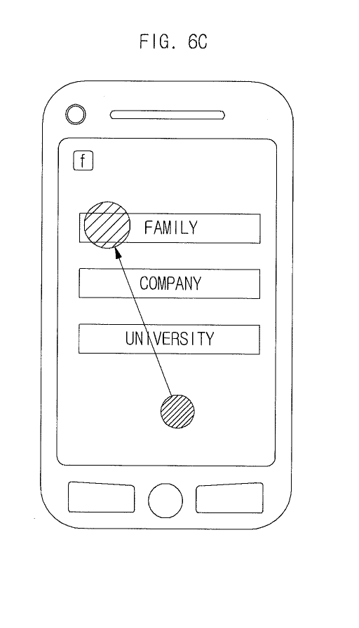

In FIG. 6, types of social relation groups to be allowed when data sharing is started may be selected in a drag-and-drop method as shown in FIG. 6A. When an existing social group is selected, a list of social networking services registered by the user is viewed as shown in FIG. 6B, and when one of the social networking services is selected, a list of a social relation group obtained from any social networking service is viewed as shown in FIG. 6C. The lists on the screen may be replaced with text lists, images, icons, or the like.

A circle in FIG. 6C indicates a user or the user's own mobile terminal. Thus, it is possible to indicate the user's intention to share his or her data with a specific family member in the drag-and-drop method.

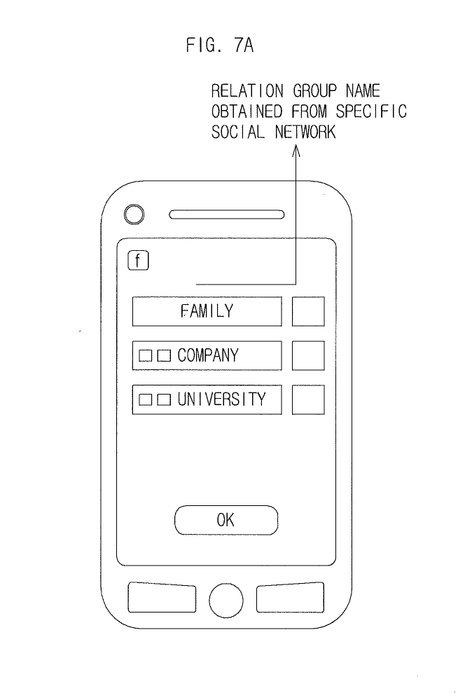

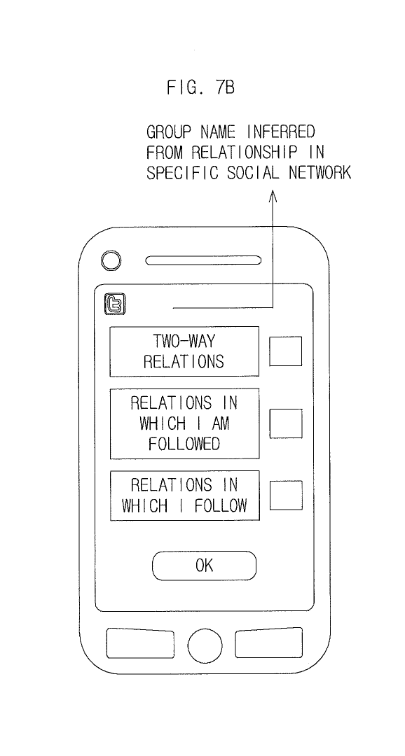

As shown in FIGS. 7A and 7B, in addition to the drag-and-drop method shown in FIG. 6C, a method in which specific groups are displayed with buttons for clicking, or a method in which specific groups are displayed with check boxes for checking and then an OK button for selecting is pushed may be used.

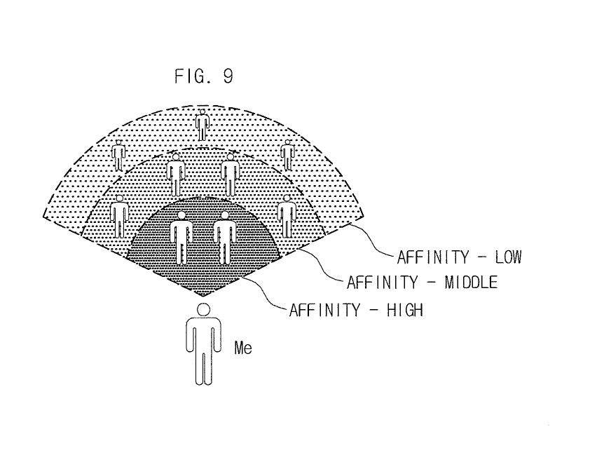

In a second method, activities in the social networking service 520 such as posting of the user, comments of other users attached to specific postings, tagging with feeling such as “like,” sharing of pictures or posts, and the like are received from a public API, and users having affinity-based active interaction are classified into a group having high affinity and users having a low interaction frequency are classified into a group having low affinity, so that dynamic affinity relation groups based on affinity may be created. The affinity-based user groups can be expressed as shown in FIG. 9.

Affinity between two users in the social networking service can be calculated through activities such as posting comments, attaching comments, sharing, tagging with feelings such as “like,” and the like as shown in the following Equation 1.

A(P₁,P₂,Tₛₜₐᵣₜ,T_{end})=Σₜ_{ₛₜₐᵣₜ}^{T}^{_{end}}Wₒᵤₜ·Activity(P₁,P₂,t)+Wᵢₙ·Activity(P₂,P₁,t) [Equation 1]

Affinity between users P₁ and P₂ during a period (Tₛₜₐᵣₜ, T_{end}) is calculated by adding up a sum of weighted values Wₒᵤₜ of outgoing activities which are performed on the user P₂ by the user P₁ and a sum of weighted values Wᵢₙ of outgoing activities which are performed on the user P₁ by the user P₂.

For example, an activity in which the user P₁ leaves a message directly to the user P₂ is added in such a manner as to multiply the weighted value Wₒᵤₜ by the corresponding activity and an activity in which the user P₂ attaches comments to posts or pictures of the user P₁ is added in such a manner as to multiply the weighted value Wᵢₙ by the corresponding activity.

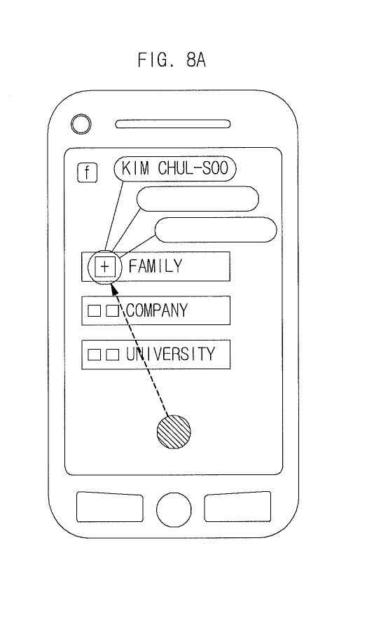

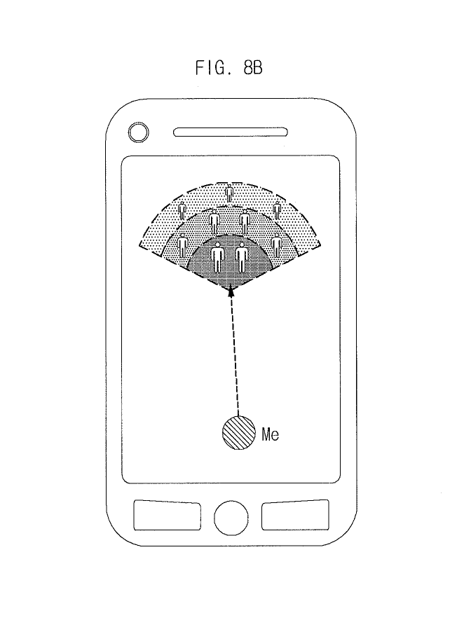

A user interface that provides a data sharing function based on the social relations based on the affinity generated in the second method is the same as in FIG. 8B. As shown in FIG. 9, a visualization of an affinity-based social network is included in the interface, a specific affinity group is selected in the drag-and-drop method by the user or the user's mobile terminal, and a lateral reciprocating motion is performed around the selected group, thereby allowing the corresponding group to perform data sharing. This can be implemented by a method in which groups are displayed in the form of buttons for clicking, or a method in which groups are displayed with check boxes for checking and then an OK button for selecting is pushed.

An interface that provides a data sharing function with a specific individual belonging to a group rather than data sharing in units of groups is configured as in FIG. 8.

In the interface using social relations provided in the existing social networking service, when pushing a “+” button in social relations, users actually included in the corresponding social relations are extended and displayed through names in the form of text, pictures, or icons as shown in FIG. 8A. The user expresses permission for data sharing with specific other users in the drag-and-drop method.

In the interface using an affinity-based social network deduced from activities in the social networking service, the user expresses permission for data sharing with specific other users in the drag-and-drop method using names, pictures, and icons which correspond to each individual as shown in FIG. 8B.

A method of requesting data sharing from another party may be performed using an interface and method of allowing the data sharing through the procedure of requesting the data sharing.

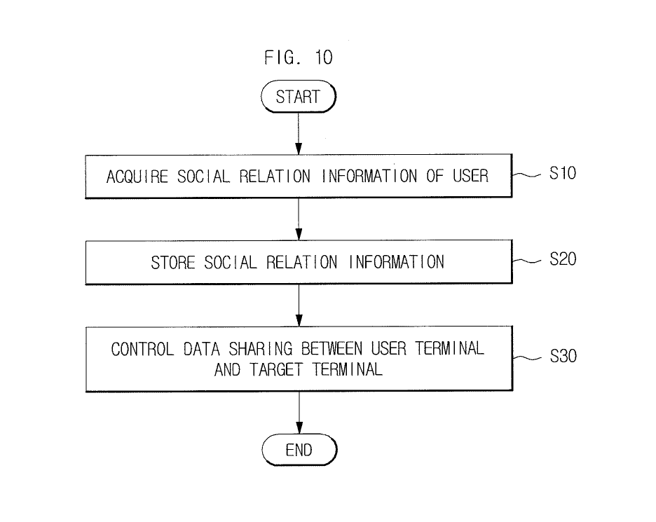

Hereinafter, a data sharing method of the data sharing apparatus 100 which has been described with reference to FIGS. 1 to 4 will be described. FIG. 10 is a flowchart schematically showing a data sharing method according to a preferred embodiment of the present invention.

First, in operation S10, the social relation information acquisition unit 110 acquires social relation information of a user by accessing an SNS server for providing an SNS.

In operation S10, the social relation information acquisition unit 110 may acquire information about acquaintances of the user as first social relation information using a public API obtained from the SNS server, or acquire information deduced based on an interaction frequency from activities performed by the user or the acquaintances of the user by accessing the SNS server through the terminal, as second social relation information. This has been described in detail above, and will be omitted here.

Next, in operation S20, the social relation information storage unit 120 stores the social relation information acquired in operation S10.

Next, in operation S30, the data sharing control unit 130 controls data sharing between a user terminal possessed by the user and a target terminal based on the social relation information stored in operation S20.

Meanwhile, between operations S20 and S30, the terminal verification unit 160 may verify whether the target terminal is a terminal possessed by an acquaintance of the user based on the stored social relation information, and the certification information generation unit 170 may generate certification information for certifying that the target terminal is the terminal possessed by the acquaintance of the user when the target terminal is the terminal possessed by the acquaintance of the user. Then, in operation S30, the data sharing control unit 130 may control the data sharing to be performed between the user terminal and the target terminal by transmitting the certification information to the user terminal.

Meanwhile, before operation S30, the model display unit 180 may display models representing each acquaintance on a screen of the user terminal, and particularly, arrange the models in order from front to back in accordance with the interaction frequency or arrange the models in order from center to outside on both sides to display the arranged models on the screen. Then, the data sharing control unit 130 controls the data sharing by using the terminal possessed by the model selected from the models displayed on the screen in operation S30 as the target terminal. Such a function of the model display unit 180 may be performed anytime before operation S30.

In this specification, exemplary embodiments of the present invention have been classified as first, second and third exemplary embodiments and described for conciseness. However, respective steps or functions of an exemplary embodiment may be combined with those of another exemplary embodiment to implement still another exemplary embodiment of the present invention.

The prevent invention can provide the following effects by sharing data between a terminal possessed by a user and another terminal using social relations of the user.

First, it is possible for a user to select a terminal to be shared. Since relations between users possessing mobile terminals rather than a device unit is used for sharing data between mobile terminals, human social relations acquired from existing social networking services can be utilized, and therefore it is possible for a user of a terminal to naturally and intuitively select a terminal to be shared in terms of actual social relations rather than in terms of the use of a device. Second, it is possible to simplify a device authentication process, and automatic setting can be performed without a user's intervention when necessary.

The above-described embodiments of the invention all the constituent components are combined into one, or the combination is said to operate as described, but the present invention is not limited to such an embodiment and the like. That is, an object of the present invention within the range, then at least one of all of its components may be selectively coupled to the motion. Further, each one of all of its components can be implemented as independent hardware, but a part or all of each of the elements that are selectively combined to form one or a plurality of combinations of some or all of the hardware that performs the functions of the program modules and may be implemented as a computer program. In addition, such a computer program is a USB memory, CD disks, flash memory, etc. The computer readable recording medium (Computer Readable Media) are stored by being read and executed by a computer, and therefore embodiments of the present invention can be implemented. The recording medium of the computer program may include magnetic recording media, optical recording media, carrier wave media, and the like.

Moreover, all technical and scientific terms including terms are, in the detailed description, unless otherwise defined, the present invention is not skilled in the art as commonly understood by one party the same meaning. The term pre-defined terms are commonly used as in the related art that include contextual meaning to be interpreted consistent with the present invention, unless otherwise defined explicitly, an idealistic or excessively formalistic meaning shall not be interpreted.

The above description of the spirit of the invention as just described by way of example particularly, the present invention is not skilled in the art to grow up without departing from the essential characteristics of this invention within a range that various modifications, changes, and substitutions are possible, will. Accordingly, the invention disclosed in the embodiments and accompanying drawings are to limit the technical scope of the present invention, not for explaining a will, in such an embodiment and the accompanying drawings by the technical scope of the present invention is not limited thereto. The scope of protection of the invention is to be interpreted by the following claims, and that all the technical ideas within the equivalent scope of the scope of the present invention should be construed as being included.

What is claimed is:

1. A data sharing apparatus using social relations, comprising:
a social relation information acquisition unit that accesses a social network service (SNS) server for providing an SNS to acquire social relation information of a user;
a social relation information storage unit that stores the acquired social relation information; and
a data sharing control unit that controls data sharing between a user terminal possessed by the user and a target terminal based on the stored social relation information.

2. The data sharing apparatus of claim 1, wherein the social relation information acquisition unit acquires information about acquaintances of the user as first social relation information using a public API obtained from the SNS server, or acquires information deduced based on an interaction frequency from activities performed by the user or the acquaintances by accessing the SNS server through the terminal, as second social relation information.

3. The data sharing apparatus of claim 2, wherein the social relation information acquisition unit includes
a grouping unit that groups the acquaintances of the user in accordance with a determined reference when the acquaintances of the user are not grouped, and
a list collection unit that acquires a group list generated in advance using the public API and an acquaintance list included in each group as the first social relation information, or acquires a group list generated through grouping in accordance with the predetermined reference using the public API and the acquaintance list included in each group as the first social relation information.

4. The data sharing apparatus of claim 2, wherein the social relation information acquisition unit includes
an activity collection unit that collects activities generated by the user or the acquaintances in accordance with at least one method of posting, comments, tagging, and sharing setting,
an activity extraction unit that extracts activities generated by a selected specific person among the acquaintances with respect to the user from the collected activities and activities generated by the user with respect to the specific person,
an interaction frequency calculation unit that calculates an interaction frequency between the user and the specific person by adding up the extracted activities,
a frequency calculation control unit that repeatedly drives the activity extraction unit and the interaction frequency calculation unit until the interaction frequencies with respect to all of the acquaintances are calculated, and
a group information acquisition unit that groups the acquaintances in accordance with at least one reference value based on the interaction frequency calculated for each of the acquaintances, and acquires information acquired through grouping as the second social relation information.

5. The data sharing apparatus of claim 1, further comprising:
a terminal verification unit that verifies whether the target terminal is a terminal possessed by the acquaintance of the user based on the stored social relation information; and
a certification information generation unit that generates certification information for certifying that the target terminal is the terminal possessed by the acquaintance of the user when the target terminal is the terminal possessed by the acquaintance of the user,
wherein the data sharing control unit controls the data sharing to be performed between the user terminal and the target terminal by transmitting the certification information to the user terminal.

6. The data sharing apparatus of claim 2, further comprising:
a model display unit that displays models representing each acquaintance on a screen of the user terminal, and arranges the models in order from front to back in accordance with the interaction frequency or arranges the models in order from center to outside on both sides to display the arranged models on the screen,
wherein the data sharing control unit controls the data sharing by using the terminal possessed by the model selected from the models displayed on the screen as the target terminal.

7. The data sharing apparatus of claim 6, wherein the model display unit uses any one of a name, a picture, and an icon of each acquaintance as the model representing each acquaintance.

8. A data sharing method comprising:
acquiring social relation information of a user by accessing an SNS server for providing an SNS;
storing the acquired social relation information; and
controlling data sharing between a user terminal possessed by the user and a target terminal based on the stored social relation information.

9. The data sharing method of claim 8, wherein the acquiring of the social relation information includes
acquiring information about acquaintances of the user as first social relation information using a public API obtained from the SNS server or acquiring information deduced based on an interaction frequency from activities performed by the user or the acquaintances by accessing the SNS server through the terminal, as second social relation information.

10. The data sharing method of claim 9, wherein the acquiring of the social relation information includes
grouping the acquaintances of the user in accordance with a determined reference when the acquaintances of the user are not grouped, and
acquiring a group list generated in advance using the public API and an acquaintance list included in each group as the first social relation information, or acquiring a group list generated through grouping in accordance with the predetermined reference using the public API and the acquaintance list included in each group as the first social relation information.

11. The data sharing method of claim 9, wherein the acquiring of the social relation information includes
collecting activities generated by the user or the acquaintances in accordance with at least one method of posting, comments, tagging, and sharing setting,
extracting activities generated by a selected specific person among the acquaintances with respect to the user from the collected activities and activities generated by the user with respect to the specific person,
calculating an interaction frequency between the user and the specific person by adding up the extracted activities,
repeatedly performing the extracting of the activities and the calculating of the interaction frequency with respect to all of the acquaintances are calculated, and
grouping the acquaintances in accordance with at least one reference value based on the interaction frequency calculated for each of the acquaintances, and acquiring information acquired through grouping as the second social relation information.

12. The data sharing method of claim 8, further comprising:
verifying whether the target terminal is a terminal possessed by the acquaintance of the user based on the stored social relation information; and
generating certification information for certifying that the target terminal is the terminal possessed by the acquaintance of the user when the target terminal is the terminal possessed by the acquaintance of the user,
wherein the controlling of the data sharing includes controlling the data sharing to be performed between the user terminal and the target terminal by transmitting the certification information to the user terminal.

13. The data sharing method of claim 9, further comprising:
displaying models representing each acquaintance on a screen of the user terminal, and arranging the models in order from front to back in accordance with the interaction frequency or arranging the models in order from center to outside on both sides to display the arranged models on the screen,
wherein the controlling of the data sharing includes controlling the data sharing by using the terminal possessed by the model selected from the models displayed on the screen as the target terminal.
